(19) United States
(12) Patent Application Publication
(10) Pub. No.: US 2026/0031532 A1
(43) Pub. Date: Jan. 29, 2026

(54) SATELLITE ANTENNA BASED ON DIRECT DRIVE MOTOR

(71) Applicant: KNS INC., Daejeon (KR)

(72) Inventors: BYEONG WOOK JIN, Daejeon (KR); GIL SANG RYU, Daejeon (KR); YOUNG SUN KIM, Daejeon (KR)

(21) Appl. No.: 18/944,217

(22) Filed: Nov. 12, 2024

(30) Foreign Application Priority Data
Jul. 23, 2024 (KR) 10-2024-0097323

(51) Int. Cl. H01Q 3/08; H01Q 1/28

(52) U.S. Cl. CPC H01Q 3/08; H01Q 1/288

(57) ABSTRACT

A satellite antenna is based on direct drive motors. The satellite antenna includes driven shafts for adjusting rotation associated with two axes including an elevation angle and an azimuth angle or three axes further associated with a cross level angle, and direct drive motors connected directly to the driven shafts, respectively, so as to rotate the driven shafts. A load, a bearing, and an angle sensor are installed on each of the driven shafts.

### CROSS-REFERENCE TO RELATED APPLICATION AND CLAIM OF PRIORITY

This application claims the benefit under 35 USC § 119 of Korean Patent Application No. 10-2024-0097323, filed on Jul. 23, 2024, in the Korean Intellectual Property Office, the entire disclosure of which are incorporated herein by reference for all purposes.

### BACKGROUND

### 1. Technical Field

The present invention relates to a satellite antenna based on direct drive motors.

### 2. Description of the Related Art

The belt drive mechanism entails low costs in terms of manufacture and maintenance and provides a high degree of freedom in its structural form but also entails the problems of high noise and low durability. The conventional satellite antenna uses such a belt drive mechanism for controlling the elevation, azimuth, and cross level angles. However, the belt drive system requires a complicated system for transmitting the drive energy, which may result in the durability being lowered even further, and, when applied for military purposes in particular, may not readily satisfy the necessary durability specifications (MIL-STD-901D (impact), MIL-STD-167 (vibration)).

### SUMMARY

An aspect of the present invention, which was conceived to resolve the problem described above, is to provide a satellite antenna based on direct drive motors that can provide increased durability and can be stabilized with a higher level of precision.

Also, an aspect of the invention is to provide a satellite antenna based on direct drive motors that can increase energy efficiency and can perform operations in a stable manner in preparation for occurrences of malfunctions, etc., by using an additional auxiliary motor that allows easier manufacture and maintenance.

Other objectives of the present invention will be more clearly understood from the embodiments set forth below.

One aspect of the invention provides a satellite antenna based on direct drive motors that includes: driven shafts for adjusting rotation associated with two axes including an elevation angle and an azimuth angle or three axes further associated with a cross level angle; and direct drive motors connected directly to the driven shafts, respectively, so as to rotate the driven shafts, wherein a load, a bearing, and an angle sensor are installed on each of the driven shafts.

Here, the satellite antenna can further include at least one or more auxiliary motor that is connected to one of the driven shafts by way of a belt.

Also, the satellite antenna can further include a power module configured to supply power from the outside to the direct drive motors; and a battery configured to provide power to the auxiliary motor and configured to be charged by solar generation.

Also, the satellite antenna can further include a control module that is configured to control the operation of the direct drive motors and the auxiliary motor, wherein the control module can operate the auxiliary motor with higher priority depending on the amount of power in the battery.

Also, the control module can operate any one of the direct drive motors and the auxiliary motor with higher priority for a preconfigured intricate movement.

Also, the satellite antenna can include just one auxiliary motor, wherein the one auxiliary motor can be connected by way of a belt with the driven shaft for any one of the elevation, azimuth, and cross level angles as necessary.

Also, the direct drive motors can be connected to the driven shafts respectively by way of worm gears such that the driven shafts are not rotated by external wind.

Other aspects, features, and advantages would be more clearly understood from the drawings, claims, and detailed description of the invention set forth below.

An embodiment of the invention can provide a satellite antenna that utilizes a direct drive mechanism in which the load, bearing, motor, etc., are connected to a single driven shaft, so as to provide an increased durability and stability with a higher level of precision.

Also, a satellite antenna according to an embodiment of the invention can additionally utilize an auxiliary motor based on a belt drive mechanism, which allows easier manufacture and maintenance, and can thus increase energy efficiency and perform operations in a stable manner in preparation for occurrences of malfunctions, etc.

### BRIEF DESCRIPTION OF THE DRAWINGS

FIG. 1 illustrates a satellite antenna that is configured for rotation association with the elevation, azimuth, and cross level angles.

FIG. 2 compares a direct drive motor mechanism according to an embodiment of the invention with a typical belt drive mechanism.

FIG. 3 is a functional block diagram illustrating the composition of a direct drive motor-based satellite antenna having an auxiliary motor according to an embodiment of the invention.

FIG. 4 illustrates a direct drive motor and an auxiliary motor installed on a single driven shaft according to an embodiment of the invention.

### DETAILED DESCRIPTION OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed by the present invention.

When a component is mentioned as being “coupled” or “connected” to another component, this may mean that the component is directly coupled or connected to the other component or may mean that they are coupled or connected with still another component in-between. On the other hand, if a component is mentioned as being “directly coupled” or “directly connected” to another component, this should be understood as meaning that there are no other components between the mentioned components.

While such terms as “first” and “second,” etc., can be used to describe various components, such components are not to be limited by the above terms. The above terms are used only to distinguish one component from another. For example, terms such as a first threshold value, a second threshold value, etc., used below may refer to threshold values that are pre-designated to be substantially different or partially the same. Since there is a risk of confusion arising if these concepts were to be referred to by the same term “threshold value”, the ordinal numbers first, second, etc., are added to more easily differentiate the concepts.

The terms used in the present specification are merely used to describe particular embodiments and are not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

Also, the components of an embodiment described with reference to each drawing are not necessarily applied exclusively to the corresponding embodiment and can be implemented so as to be included in another embodiment as long as the spirit of the invention is maintained. Moreover, is should be appreciated that multiple embodiments can be implemented as a single combined embodiment, even though it is not expressly stated as such.

In describing the appended drawings, the same components are assigned the same or related reference numerals regardless of the figure number, and redundant explanations are omitted. In the description of the present invention, certain detailed explanations of the related art are omitted if it is deemed that they may unnecessarily obscure the essence of the invention.

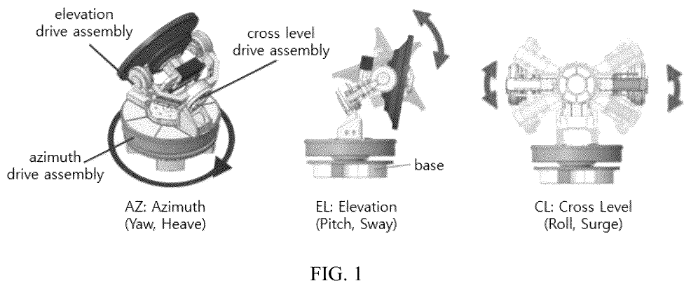

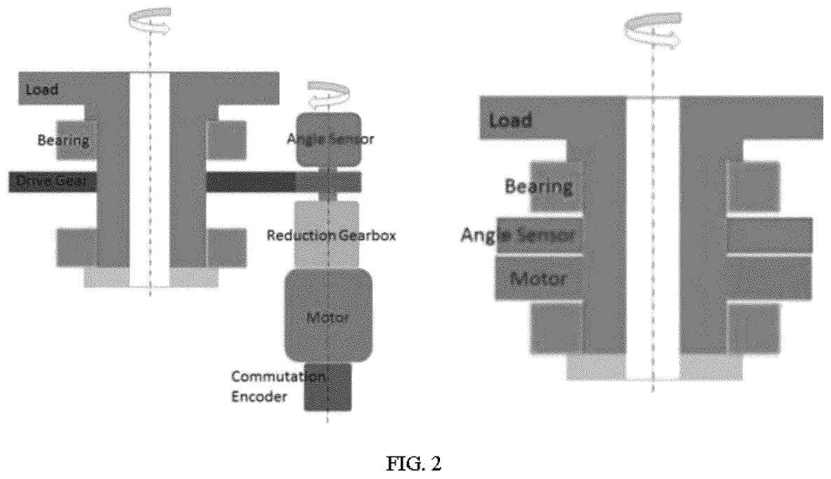

FIG. 1 illustrates a satellite antenna that is configured for rotation association with the elevation, azimuth, and cross level angles, and FIG. 2 compares a direct drive motor mechanism according to an embodiment of the invention with a typical belt drive mechanism.

To first provide a brief description of the satellite antenna system, the satellite antenna tracks a satellite through signal recognition and stabilization functions, and the antenna controller device transmits information associated with the navigation system installed on the ship and the satellite inertia to the antenna. The user can use a modem to receive emergency and aid requests and broadcasts or access telephone or Internet communications.

The satellite antenna system may include an upper radome, a lower radome, an antenna, a pedestal control unit (PCU), an inertial measurement unit (IMU), a multi-RF unit (MRU), and a pedestal.

The upper radome protects the equipment from the ocean environment, and the lower radome protects the equipment from the ocean environment and is secured to the body of the ship.

The antenna is usually a dish-shaped parabolic antenna and serves to collect or transmit satellite signals, the PCU is a device that searches and tracks the antenna, the IMU checks inertia information, the MRU is a device that processes analog and digital signals received from the satellite, and the pedestal is a mechanical structure that supports the antenna and is movable in a desired direction along each axis.

Unlike an antenna installed on land, a satellite antenna for naval applications may be mounted on a ship, and the pedestal structure on which the antenna is mounted may compensate for the disturbances occurring in the ocean environment with roll, pitch, and yaw movements, so that the antenna may be directed towards the target satellite as if it were a fixed antenna. Thus, a satellite antenna for naval applications can be defined as a combination of a control platform that maintains tracking and a satellite communication system that transmits signals to and from a satellite, and the movement of the antenna by the pedestal is an element of great importance.

A description is provided below of a satellite antenna having a pedestal that is based on a direct drive motor.

Referring to FIG. 1, a pedestal provided in a direct drive motor-based satellite antenna may include a mechanical structure and drive device that compensate for the movement of the ship. For instance, the existing structure may be operated for two or three axes. The two-axes type may include an azimuth drive assembly that allows 360° rotation unlimitedly for omnidirectional operation and an elevation drive assembly that moves the elevation angle within a range of −10° to 110° to compensate for movements in the ocean environment and to account for operations in polar and equatorial regions. The three-axes type may include a cross level drive assembly that adjusts the cross level by −30° to +30° to compensate the roll angle. Of course, the operation angles for each axis described above can obviously be configured in various ways.

A satellite antenna according to the present embodiment may employ a direct drive mechanism for the power transmission for each method. Compared to the belt drive mechanism, the direct drive mechanism has a high durability and is resilient against impact. The direct drive mechanism therefore has a low probability of malfunctions and enables high precision control for greater stability.

Referring to FIG. 2, a motor (referred to hereafter as the direct drive motor) may be connected directly to the driven shaft to form a direct drive mechanism, where a load, a bearing, and an angle sensor may be installed on the driven shaft.

A satellite antenna having a pedestal according to the present embodiment may be characterized by aligning the center of mass of each driven shaft with the center of rotation of each axis for all components, such as the antenna, PCU, etc., in consideration of movements of the ship caused by waves and wind as occurs in an ocean environment, the method and speed of navigation, the position of installation, and the vibrations and impacts occurring in the ship itself. The aligning of the center of mass and the center of rotation can minimize the torque applied on each shaft, thereby minimizing the load applied on the motor driver during the operation of each shaft and hence preventing the problem of overloading.

The direct drive mechanism may require a higher manufacturing cost and a more sophisticated design, leading to greater maintenance costs in the event of a malfunction. That is, compared to the belt drive mechanism, the direct drive mechanism may provide a lower probability of malfunctioning due to its high durability but may incur a higher maintenance cost if a malfunction does occur. To resolve this problem, an embodiment of the invention may utilize an auxiliary motor, so as to reduce the rate by which the direct drive motor is used and thus lower the probability of malfunctions. The auxiliary motor may employ a belt drive mechanism, which allows easier manufacture and maintenance. A description is provided below of a satellite antenna having an auxiliary motor.

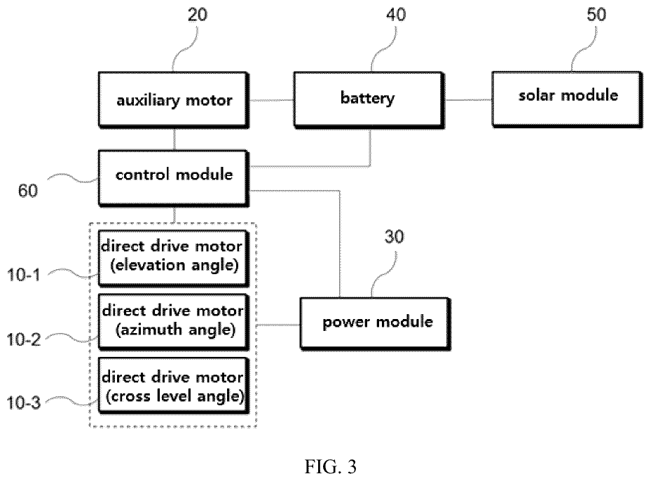

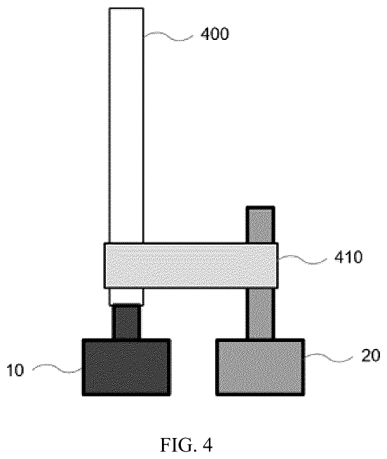

FIG. 3 is a functional block diagram illustrating the composition of a direct drive motor-based satellite antenna having an auxiliary motor according to an embodiment of the invention, and FIG. 4 illustrates a direct drive motor and an auxiliary motor installed on a single driven shaft according to an embodiment of the invention.

Referring to FIG. 3, a satellite antenna according to the present embodiment may include direct drive motors 10-1, 10-2, 10-3 (collectively referred to by the numeral 10), an auxiliary motor 20, and a control module 60.

The direct drive motors 10 may be directly connected respectively to the driven shafts for at least the two axes associated with the elevation and azimuth angles or for three axes that is further associated with the cross level angle.

The auxiliary motor 20 may be connected with one of the driven shafts by way of a belt. It is possible to include multiple (two or three) auxiliary motors 20 in correspondence to all of the driven shafts (which may be two or three in number), or to include just one auxiliary motor 20 that is installed so as to be connected to a driven shaft for any one of the elevation, azimuth, and cross level angle as necessary when the satellite antenna is installed.

That is, as illustrated in FIG. 4, a driven shaft 400 can have a direct drive motor 10 connected directly and can have an auxiliary motor 20 connected by way of a belt, allowing the driven shaft 400 to be rotated with the direct drive motor 10 or with the auxiliary motor 20 by way of the belt.

The control module 60 may control the operation of the direct drive motors 10 and the auxiliary motor 20, for example by operating the direct drive motors 10 with higher priority and operating the auxiliary motor 20 in cases where an impairment (such as a malfunction, etc.) has occurred in a direct drive motor 10. In another example, the control module may operate one of the direct drive motors 10 or the auxiliary motor 20 as necessary. For instance, a direct drive motor 10 (or the auxiliary motor 20) may be operated with higher priority for an intricate movement of a preconfigured angle or smaller. That is, since the direct drive motors 10 offer the advantage of enabling more intricate angle adjustments, such intricate movements can be made with direct drive motors 10 give higher priority, whereas movements of a threshold angle or greater can be made with the auxiliary motor 20.

Referring again to FIG. 3, a satellite antenna according to the present embodiment may further include a power module 30, a battery 40, and a solar module 50.

The power module 30 may supply outside power to the direct drive motors 10. The battery 40 may be charged with power generated by the solar module 50 and may provide the charged power to the auxiliary motor 20. In other words, the direct drive motors 10 can be constantly supplied with power from a power source, while the auxiliary motor 20 may use the power generated by solar generation.

In one example, the control module 60 may operate the auxiliary motor 20 with higher priority depending on the amount of power in the battery. For instance, the auxiliary motor 20 may be used with higher priority if the amount of charge is 50% or higher, while only the direct drive motors 10 may be used if the amount of charge is 20% or lower. This embodiment makes it possible to use energy more efficiently by giving higher priority to power charged by solar generation.

According to another embodiment of the invention, the direct drive motors can be connected to the respective driven shafts by way of worm gears, so that the driven shafts may not be rotated by external wind. As described above, a satellite antenna according to an embodiment of the invention can be installed on a ship. The ocean environment may be subject to strong external forces due to strong winds and waves, and the rotatable structure of the pedestal for the satellite antenna can cause unwanted rotations due to the winds and waves, which in turn can apply a heavy load on or even damage the direct drive structure.

Therefore, a satellite antenna according to the present embodiment can include connector parts composed of worm gears placed between the direct drive motors and the driven shafts or between the driven shafts and the pedestal, so that even if the satellite antenna experiences external wind, there would be no load transmitted to the driven shafts or the motors. For example, a worm gear can be coupled to the motor shaft of a direct drive motor, and a worm wheel can be coupled to the driven shaft. Alternatively, a worm gear can be coupled to the driven shaft, and a worm wheel can be coupled to the pedestal.

While the foregoing provides a description with reference to a preferred embodiment of the present invention, it should be appreciated that a person having ordinary skill in the relevant field of art would be able to make various modifications and alterations to the present invention without departing from the spirit and scope of the present invention set forth in the scope of claims below.

What is claimed is:

1. A satellite antenna comprising:
driven shafts configured for adjusting rotation associated with two axes including an elevation angle and an azimuth angle or three axes further associated with a cross level angle; and
direct drive motors connected directly to the driven shafts, respectively, so as to rotate the driven shafts,
wherein a load, a bearing, and an angle sensor are installed on each of the driven shafts.

2. The satellite antenna according to claim 1, further comprising at least one or more auxiliary motor connected to one of the driven shafts by way of a belt.

3. The satellite antenna according to claim 2, further comprising:
a power module configured to supply power from outside to the direct drive motors; and
a battery configured to provide power to the auxiliary motor and configured to be charged by solar generation.

4. The satellite antenna according to claim 3, further comprising a control module configured to control an operation of the direct drive motors and the auxiliary motor, wherein the control module operates the auxiliary motor with higher priority depending on an amount of power in the battery.

5. The satellite antenna according to claim 4, wherein the control module operates any one of the direct drive motors and the auxiliary motor with higher priority for a preconfigured intricate movement.

6. The satellite antenna according to claim 5, further comprising a single auxiliary motor, wherein the single auxiliary motor is connected by way of a belt with the driven shaft for any one of the elevation, azimuth, and cross level angles as necessary.

7. The satellite antenna according to claim 6, wherein the direct drive motors are connected to the driven shafts respectively by way of worm gears such that the driven shafts are not rotated by external wind.
